(19) United States
(12) Patent Application Publication
(10) Pub. No.: US 2006/0044715 A1
(43) Pub. Date: Mar. 2, 2006

(54) ESD protection cell latch-up prevention

(76) Inventors: Patrick Muggler, Dallas, TX (US); Edwin Suryahusada, Richardson, TX (US)

Correspondence Address: TEXAS INSTRUMENTS INCORPORATED, P O BOX 655474, M/S 3999, DALLAS, TX, 75265, US

(21) Appl. No.: 10/928,332

(22) Filed: Aug. 27, 2004

(51) Int. Cl. H02H 9/00

(52) U.S. Cl. 361/56

(57) ABSTRACT

Latch-up preventing circuits and methods are provided for ESD protection cells. A method of preventing latch-up in an ESD protection cell is described which includes monitoring the ESD protection cell to detect the activation of the ESD protection cell in response to an ESD event. After detection of the activation of the ESD protection cell, the supply current to the ESD protection cell is turned off, preventing latch-up. Circuit embodiments are described in which ESD protection circuits include are provided with a detection and reset circuit. The circuit is adapted to turn off the supply current to the ESD protection cell upon the detection of the activation of the ESD cell.

### TECHNICAL FIELD

The invention relates to electrostatic discharge (ESD) protection circuitry. More particularly, the invention relates to methods and circuitry for preventing latch-up in ESD protection circuits, including silicon controlled rectifier (SCR) ESD protection cells.

### BACKGROUND OF THE INVENTION

Electrostatic discharge (ESD) events can cause damage to elements of circuitry due to current overload or reverse biasing. For example, the propagation of an ESD event through a circuit may cause a transistor to greatly exceed its current capacity, suffer physical damage, and subsequently fail. The potential for failure increases as circuitry becomes smaller and as voltage levels are reduced. ESD events may occur due to a relatively short period of high voltage or current imposed on a device. For example, ESD events are sometimes caused by contact with a human body, by machinery such as manufacturing or test equipment, or in electrically noisy environments, as may be incurred in many consumer applications. A variety of ESD events can occur in electronic devices, including discharge between the pads of an integrated circuit, discharge between voltage supply terminals, and discharge between pads and voltage supply terminals. Various ESD protection circuitry is used in the arts to protect ICs from damage due to the occurrence of ESD events during manufacture, testing, and operation. In general, ESD protection circuitry is designed to protect the input/output circuitry and internal circuitry of an integrated circuit from excessively large and sudden discharges of electrostatic energy. Each pin in an integrated circuit must be coupled to an appropriate ESD protection circuit such that the ESD discharge current is shunted away from the internal portions of the chip that are the most sensitive to damage. As such, ESD discharge paths must be provided between every pair of pins in an IC for both positive and negative polarities.

ESD discharges are brief transient events that are usually less than one microsecond in duration and much higher in voltage than the normal operating voltage range. Furthermore, the rise times associated with these brief pulses are usually less than approximately twenty nanoseconds. The ESD protection circuit must be able to detect these fast large transients and begin conducting so as to shunt the resulting ESD current. However, the ESD protection circuit must not respond to the much smaller voltage increases of normal power-up events in usual chip operation. If the ESD protection circuit were to trigger and conduct during normal power-up events, the desired operation of the IC could be compromised. Furthermore, in addition to triggering when needed for ESD protection, the ESD protection circuit must stay in a highly conductive state for the duration of the ESD pulse so that all of the ESD energy is safely discharged. If the ESD protection circuit were to shut down prematurely, damaging potentials could build up quickly and cause device failure. Yet another conflicting demand on an ESD protection circuit, however, is the need to shut down when ESD protection is no longer needed after an ESD event. Many ESD protection cells known in the art have a tendency to latch-up in an “on” state after an ESD event. One skilled in the arts is required to balance the tradeoffs among factors including ESD protection, resistance, and chip area constraints.

It is known to use silicon controlled rectifier (SCR) ESD protection cells in some applications, primarily due to economies in die area. One problem with SCR ESD protection cells that prevents their more widespread use, is that they have a higher activation threshold than their holding voltage. As a result, latch-up conditions occur, in which an SCR ESD protection cell can remain in an “on” state beyond the duration of a triggering ESD event. This is undesirable from a power consumption standpoint, as the latched ESD protection cell is permitted to draw supply current during periods when ESD protection is not required. The operation of a common SCR ESD protection cell is represented in the graph of FIG. 1. Representative of the current and voltage in an ESD protection cell, the voltage is shown along the x-axis, and the current along the y-axis of the graph of FIG. 1. The ESD protection cell is activated when the voltage on an ESD-protected pin increases beyond a certain activation threshold voltage, shown by point A. The holding voltage of the ESD cell is shown by point B. A problem with state-of-the art SCR ESD cells is that they have a much higher activation threshold voltage (point A) than the holding voltage (point B). This causes the ESD cell to latch-up, increasing power consumption by remaining “on” when ESD protection is not required. Thus, although ESD protection is provided, protecting the associated IC from damage due to over-voltage stress, quiescent current consumption is higher than it might otherwise be.

Due to these and other problems, a need exists for circuits and methods that provide microelectronic circuits with the ability to withstand ESD events without adversely impacting the performance of the functional circuit path during normal operation. Particular problems lie in the ever-present desire to reduce die area, and to reduce the occurrence of latch-up.

### SUMMARY OF THE INVENTION

In carrying out the principles of the present invention, in accordance with preferred embodiments thereof, ESD protection is provided which includes latch-up preventing circuits and methods.

According to an exemplary preferred embodiment of the invention, a method of preventing latch-up in an ESD protection cell operably coupled to associated circuitry includes a step of monitoring the ESD protection cell in order to detect the activation of the ESD protection cell in response to an ESD event. In a further step, after detection of the activation of the ESD protection cell, the supply current to the ESD protection cell is turned off, thereby preventing latch-up.

According to another aspect of the invention, circuit embodiments are disclosed in which ESD protection circuits include an ESD protection cell operably coupled to associated circuitry. A detection circuit is provided for monitoring the ESD cell in order to detect the activation of the ESD cell. The detection circuit is adapted to turn off the supply current to ESD protection cell upon the detection of the activation of the ESD cell. A reset counter operably coupled to the detection circuit is used for resetting the detection circuit.

According to additional aspects of the invention, preferred embodiments are implemented in combination with SCR ESD protection cells.

The invention has numerous advantages including but not limited to providing reliable latch-up prevention in ESD protection circuitry, providing savings in power consumption, and reductions in die area. These and other features, advantages, and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 (prior art) is a graphical representation showing an example of ESD voltage and supply current in an SCR ESD cell known in the arts during an ESD event;

FIG. 2 is a simplified block diagram illustrating an example of preferred embodiments of the invention; and

FIG. 3 is a graphical representation showing an example of ESD voltage and supply current in an SCR ESD according to the invention during an ESD event.

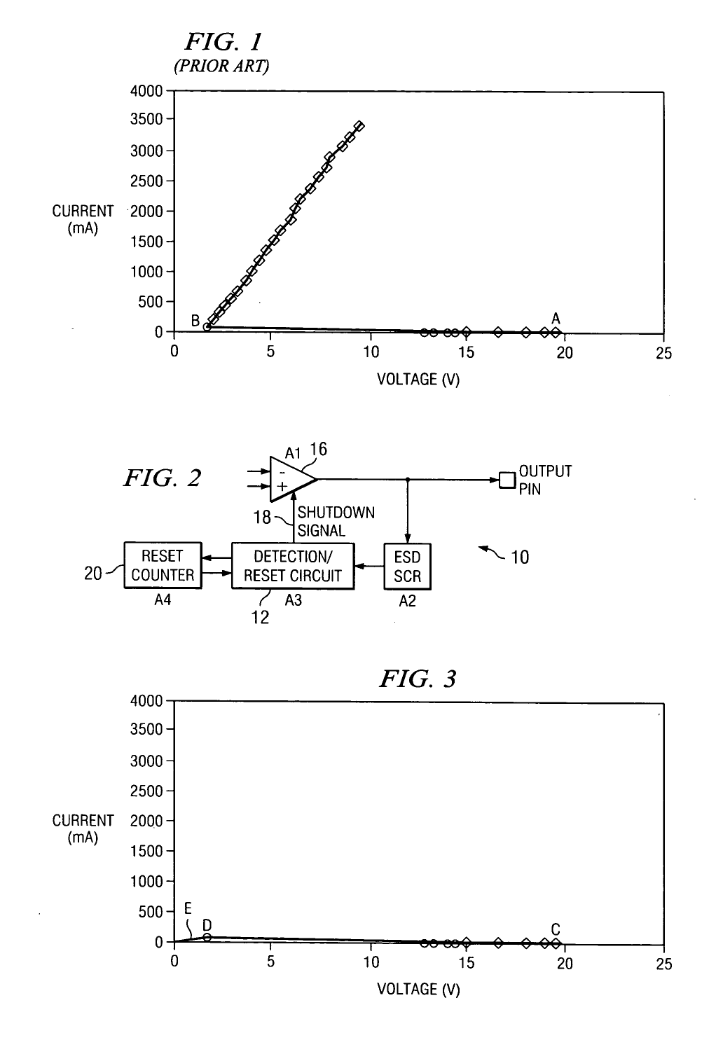

References in the detailed description correspond to like references in the figures unless otherwise noted. Descriptive and directional terms used in the written description such as first, second, top, bottom, upper, side, etc., refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DETAILED DESCRIPTION OF PREFERRED EMBODIMENTS

The invention provides an ESD protection cell 10 with a detection and reset circuit 12. The ESD protection cell 10 is preferably a silicon controlled rectifier (SCR) circuit known in the arts, although other ESD protection cells may be used. The ESD protection cell 10 provides protection to associated IC circuitry represented by op amp 16 for the sake of this example. Those skilled in the arts will appreciate that the protected circuitry 16 may take many alternative forms without affecting the practice of the invention. Typically, the ESD protection cell 10 is provided with suitable means (not shown) for detecting the occurrence of ESD events and activating the ESD protection cell 10.

The ESD protection cell 10 is used to protect the associated circuitry 16 from potentially damaging ESD events as known in the arts. The detection and reset circuit 12 is designed to detect the activation of the ESD protection cell 10. It should be understood that the detection and reset circuit 12 monitors the ESD protection cell 10 activity and not the occurrence of an ESD event directly. After detecting the activation of the ESD protection cell 10, the detection and reset circuit 12 sends a shutdown signal, represented by arrow path 18, to turn off the supply current for the ESD protection cell 10. By turning off the supply current to the ESD protection cell 10, the ESD protection cell 10 is reset to its “off” or stand-by state. A suitable delay may be pre-programmed for the detection and reset circuit 12 according to application requirements.

Thus, latch-up of the ESD protection cell 10 in the active state is prevented by the detection and reset functions of the invention. The detection and reset circuit 12 may be embodied in numerous alternative physical circuits without departure from the principles of the invention. Preferably, the detection and reset circuit 12 is provided with a capability for self-resetting after a preselected delay interval, such as may be provided using a reset counter 20, for example.

Now referring primarily to FIG. 3, the operation of a preferred embodiment of the invention as exemplified in FIG. 2 is described. On the graph of FIG. 3, the voltage at the ESD protection cell is represented along the x-axis, and the current to the ESD protection cell is represented along the y-axis. The ESD protection cell is activated to provide a shunting path upon the detection of an ESD voltage, as shown by point C. Subsequent to the ESD event, the ESD protection cell voltage drops to a holding voltage, represented by point D. Deactivation of the ESD protection cell supply current according to the invention ensures that the current returns to zero as represented by segment E.

The methods and devices of the invention provide advantages including but not limited to providing improved ESD protection using less die area preventing latch-up and associated current loss. While the invention has been described with reference to certain illustrative embodiments, the methods and systems described are not intended to be construed in a limiting sense. Various modifications and combinations of the illustrative embodiments as well as other advantages and embodiments of the invention will be apparent to persons skilled in the art upon reference to the description and claims.

We claim:

1. In an ESD protection cell operably coupled to associated circuitry, a method of preventing ESD protection cell latch-up comprising the steps of:
monitoring the ESD protection cell in order to detect the activation of the ESD protection cell responsive to an ESD event; and
upon detection of the activation of the ESD protection cell, turning off the supply current of the ESD protection cell, thereby resetting the ESD protection cell and preventing latch-up.

2. A method according to claim 1 wherein the ESD protection cell further comprises a silicon controlled rectifier circuit.

3. A method according to claim 1 further comprising the step of, subsequent to the detection of the activation of the ESD protection cell, delaying for a selected interval prior to resetting the ESD protection cell.

4. An ESD protection circuit comprising:
an ESD protection cell operably coupled to associated circuitry;
a detection circuit for monitoring the ESD protection cell in order to detect the activation of the ESD protection cell, the detection circuit further adapted to turn off the ESD protection cell upon the detection of the activation of the ESD protection cell; and
a reset counter operably coupled to the detection circuit for resetting the detection circuit.

5. A circuit according to claim 4 wherein the ESD protection cell further comprises a silicon controlled rectifier circuit.

6. A circuit according to claim 4 wherein the detection circuit is further configured to delay for a selected time interval prior to resetting the ESD protection cell.

7. A circuit according to claim 4 wherein the detection circuit is further configured to delay for a selected time interval prior to resetting.
